(19) United States
(12) Patent Application Publication
(10) Pub. No.: US 2022/0248708 A1
(43) Pub. Date: Aug. 11, 2022

(54) ICE CREAM MACHINE

(71) Applicants: ANGELO TONDINI, SUMIRAGO (IT); MARCO TONDINI, GALLARATE (IT)

(72) Inventors: ANGELO TONDINI, SUMIRAGO (IT); MARCO TONDINI, GALLARATE (IT)

(21) Appl. No.: 17/616,393

(22) PCT Filed: May 27, 2020
(86) PCT No.: PCT/IB2020/055009

§ 371 Date: Dec. 3, 2021

(30) Foreign Application Priority Data
Jun. 5, 2019 (IT) 102019000008094

(51) Int. Cl. A23G 9/12; B65D 85/78

(52) U.S. Cl. CPC A23G 9/12; B65D 85/78

(57) ABSTRACT

An ice cream maker is disclosed, comprising a cooling unit (4A; 10; 13) and a stirring container (4), characterised in that said stirring container (4) consists of a compartment where the ingredients for the final product are added in the form of cartridge or capsule (15) which is opened and stirred in upon production.

The present invention refers to a household appliance, in particular to an ice cream machine, apt to the home or handicraft production of ice creams or similar compositions.

According to the definition reported by Wikipedia, ice cream is a food preparation obtained from a mixture of ingredients, brought to the solid or semi-solid state by freezing and simultaneous stirring by air blowing.

Ice cream is a very well-known food, extremely popular and universally appreciated, especially in hot seasons and locations.

The origins of ice cream, although it has changed a lot over the years, are rather old. Even discarding findings of the Neanderthal period—which probably concerned something extremely different from ice cream as we understand it today (probably preserved fruit)—maybe already in Sicily, in the period of the Arab domination, the first sherbets came to be known: mixtures of water, cane sugar (which the Arabs had imported into Sicily), herbs and spices. In some caves of the Sicilian Pennine winter snow used to be stored, which turned into ice, which was then sold in summer. Such ice was put around a container filled with the ingredients, salt was added (easily and widely available in Sicily) which had the effect of lowering the ice melting temperature, thus obtaining sherbet inside the container. In Sardinia, in a similar way, carapigna was manufactured, an iced mixture of water, sugar and lemon, which established itself from 1600 onwards.

Although ice cream was born in Italy—and Italian ice cream is still celebrated almost everywhere—its introduction into France decreed the luck thereof. Francesco Procopio dei Coltelli, a Sicilian cook, managed in the XVII century to manufacture, by the means illustrated above, ice cream as we understand it today and sold it in a café he had opened in Paris.

Ice cream production occurs today by more moderns and handy tools. In general, ice cream and sherbet are manufactured using a household appliance, commonly called ice cream maker. In practice, the mixture is prepared separately, normally a sort of liquid syrup of various density, which is then poured into a suitable tray, which is chilled by suitable dedicated means, such as a refrigerator, or the tray is stored in a freezer for a rather long time, so as to maintain the cold for the time necessary to produce the ice cream. Normally, the tray internally comprises blades which rotate with a fixed tray or which remain stationary with tray rotation, depending on the ice cream maker model. The blades meet the resistance of the syrup, thus inputting air which causes the mixture, instead of solidifying into a block, as it would do if left idle, to swell and solidify like a cream. Once the product has reached the desired texture, movement is stopped and the ice cream is served; the product which should be left over is brought to a temperature below 0° C., before it starts melting, so as to preserve it in the form of cream, which adds to the taste and to the fresh effect, also a very pleasant and appreciated texture, which allows to enjoy a more intense flavour.

Ice cream makers of all types and of all sizes exist. Thereby, industrial machinery exists for industrial ice cream, professional equipment for the production of hand-made ice cream in ice cream makers and small machines, for the direct domestic production. The principle of operation of these machines is substantially the same.

Next to ice creams and sherbets, in the last few years, other chilled products have been established, highly appreciated by the public, such as crushed ice drinks, so-called frozen yogurt and various fruit mousses.

Granita (grated ice drink)—a typical Sicilian sweet—is a semi-frozen liquid, prepared from a syrup, normally made from water, sugar and fruit, but varieties with coffee and peppermint exist. For its production, freezing occurs gradually, shaking, but without the addition of air. A sort of ice custard is obtained, wherein, unlike what must occur for ice cream and sherbet, small ice crystals must be perceived.

Frozen yogurt is a yogurt-based sweet, similar to ice cream, but with less fat and more acidic in flavour; however, unlike yogurt, frozen yogurt does not contain live milk enzymes.

Generally, ice cream makers can produce both ice creams and sherbets, but not frozen yogurt, mousses nor crushed ice drinks, for these preparations different equipment and procedures being required.

The domestic production of ice cream is an activity which gives great satisfaction and allows to obtain a product of an ideal texture upon serving it, if one proceeds correctly. A product with a better texture and flavour can hence be obtained than that which one could purchase from an ice cream parlour. However, there are some difficulties. Firstly, the preparation of the mixture to be mixed in the ice cream maker is not trivial and requires a certain culinary skill, to avoid having a product with unbalanced flavours. Secondly, the preparation requires a rather long time. In particular, the mixture is normally prepared by cutting or dicing fruit or extracting the juice thereof, mixing it with water or cream, possibly with milk, sugar and/or eggs, often causing the mixture to reach the boil, after which it is necessary to wait for the mixture to cool down sufficiently to be able to obtain the desired ice cream.

Mixture cooling can be critical. If, for example, one uses an ice cream maker the tray of which is cooled in a freezer or the like before proceeding to pour in the mixture and mixing in—outside of the freezer, mostly at the outer room temperature it is necessary for the liquid to be poured at room temperature or lower; it is generally suitable, after cooling to room temperature, to store in the fridge the mixture before it undergoes mixing, to avoid that it heats up the tray too much, thereby preventing the ice cream from solidifying correctly.

The problem at the basis of the invention is to propose an ice cream maker which overcomes the mentioned drawbacks relating to the preparation of the base and which allows to obtain ice creams and sherbets, but also frozen yogurt, mousses and crushed ice drinks, without requiring too long production times and minimising the operations of removal of the final compound and of cleaning the apparatus. This object is achieved through an ice cream maker, comprising a cooling unit and one or more mixing containers, characterised in that said mixing container consists of a compartment wherein the ingredients for the final product are added in the form of cartridge or capsule which is opened and stirred in within the same container upon production. The dependent claims describe preferential features of the invention.

Further features and advantages of the invention are in any case more apparent from the following detailed description of a preferred embodiment, given purely as a non-limiting example and illustrated in the attached drawings, wherein:

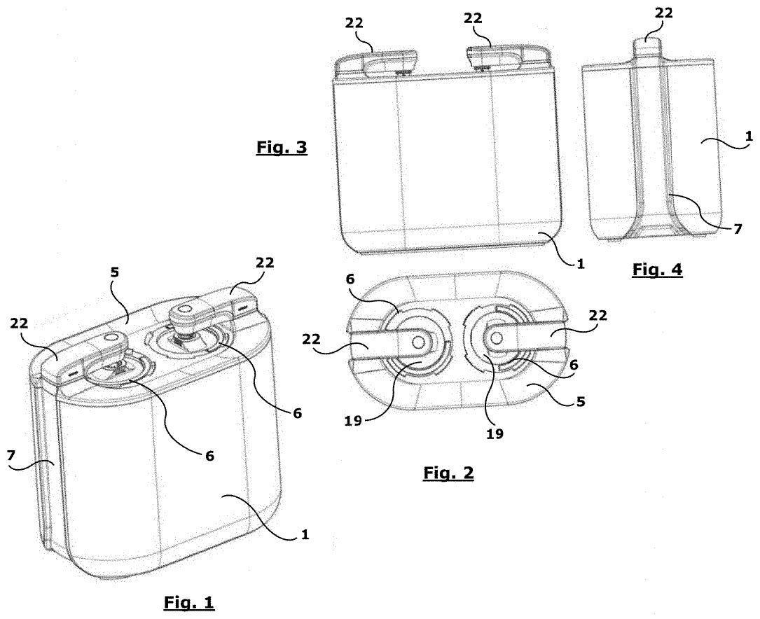

FIG. 1 is a perspective view of an ice cream maker according to the present invention;

FIG. 2 is a plan view of the ice cream maker of FIG. 1;

FIG. 3 is a view of the ice cream maker of the previous figs., in front view;

FIG. 4 is a side view of an ice cream maker according to the present invention; and

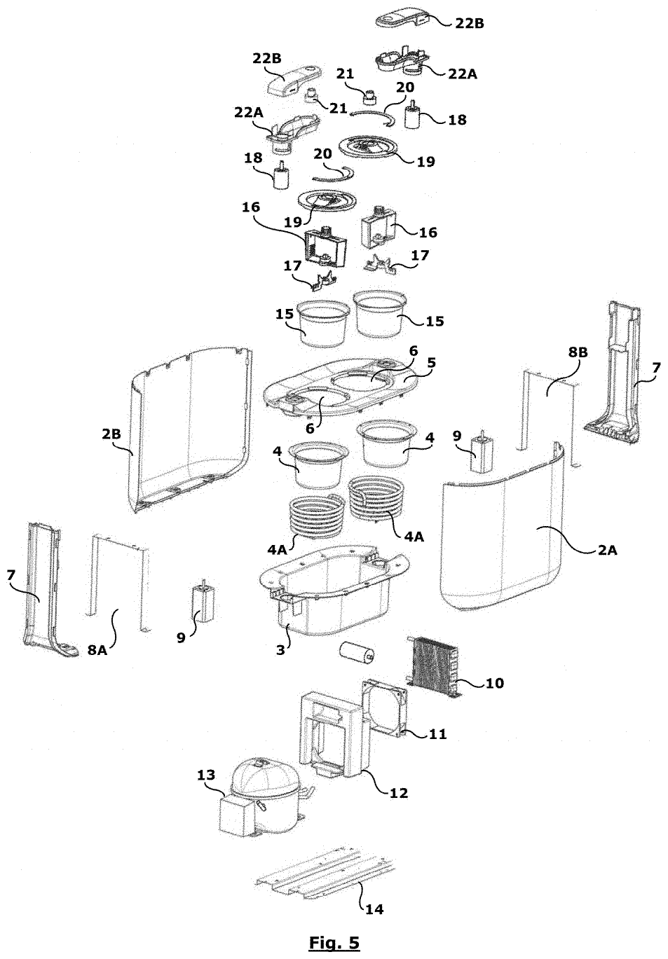

FIG. 5 is an exploded view of an ice cream maker according to the present invention.

The ice cream maker according to the present invention comprises a box 1, consisting of two half-shells 2A and 2B, for example of a plastic material. Within chamber 1 a tray 3 is contained; it also is preferably made of an insulating material. Tray 3 is capable of housing chambers 4 (in the drawings, two are shown), each one wound with a cooler 4A, manufactured as a heat exchanger, preferably in the form of serpentine run-through by a coolant.

Box 1 is closed, above chambers 4, by a cover 5, which has openings 6, each one in correspondence of a chamber 4. Box 1 also has two front bands 7, which can have a purely decorative function or be useful to close the two half-shells 2A, 2B. Advantageously, tray 4 is joined to half-shells 2A, 2B by supports 8A, 8B. With each chamber 4 a motor 9 is associated, a shaft of which (not visible in order not to make the drawing difficult to understand) protrudes within relative chamber 4. A condenser 10 can be provided within box 1 and, in correspondence thereof, a fan 11 is found, carried by a support 12. Coolers 4A are connected to a compressor 13, which rests on a crossmember 14. The parts just shown are all fixedly contained in box 1 and, unless maintenance operations, they are not normally moved.

For the operation, there are parts which are instead inserted and removed at the beginning and end of use, respectively.

Firstly, there are capsules 15, of such a shape and size to be able to be inserted into chambers 4. Capsules 15 contain a preparation, mostly liquid or viscous, which contains all the ingredients necessary to obtain the desired product and which have undergone all the preparation steps, except for the final mixing. There are blades 16, of such a size to be able to be inserted with a respective insert 17 into waffles 15. A coupling 18 allows to adapt blades 16 to a cover 19 which has a handle 20. Preferably, cover 19 provides one or more openings, to allow the addition of any supplementary fittings (not contained in original capsule 15) during the preparation, to improve the taste and/or to make the aesthetic appearance thereof more enticing. Coupling 18 also connects, through a transmission 21, to a covering system 22, consisting of a lower part 22A and of an upper part 22B.

Based on an alternative embodiment, motor 9, instead of providing a small shaft protruding directly into chamber 4, as illustrated earlier, can provide a transmission system which actuates a small shaft carried by cover 22 and which runs through cover 19.

As concerns operation, switching on the ice cream maker according to the present invention automatically activates also the cooling circuit, causing coolant to flow through coolers 4A.

Generally, the temperature inside the chambers wound by said coolers 4A can be caused to drop as low as −35° C., according to needs.

Capsules 15, preferably stored in the fridge before use, contain—as stated—the agent to be used to obtain the desired product, be it ice cream, sherbet, frozen yogurt, mousse, or crushed ice drink or other; naturally, the preparation in capsule 15 and the operating conditions of the ice cream maker will be different, depending on the type of final product desired. Preferably, capsules 15 will have a face (the upper one in the drawings) closed by a removable film. Capsule 15 can be of a recyclable plastic material (for example, of PVC, melamine, polyethylene, polypropylene, vynyl-ethylene alcohol or other), or of aluminum or it can be made of a recyclable plastic material, internally and/or externally coated with aluminum or with another thermoconductive metal which increases the thermal conductivity thereof. The closing film can also be of a plastic material or of aluminum.

Once the removable film has been removed, capsule 15 is introduced, passing through the relative opening 6 of cover 5 into one of chambers 4, thus coming into contact with the wall of said cover, cooled by the relative cooler 4A. If present, insert 17 is inserted onto the bottom of capsule 15, generally being wedge-shaped. Insert 17 has the function of easing the introduction and the arrangement of blade 16 in capsule 4; however, the blade 16 can be inserted also in the absence of insert 17 which is not necessary, although it is useful to have a better operation of the ice cream maker. In any case, the introduction of capsule 15 into chamber 4 must cause the shaft of motor 9 to go through the bottom and engage with blade 16. Alternatively, a shaft can be prepared within capsule 15, driven into rotation by a transmission connected to motor 9 on the outside of the bottom of capsule 15 or the blade can be driven from above. Capsules 15 can contain equal products as well as different products.

Through coupling 18, blade 16 is adapted to a cover 19, which is then closed by closing system 22, which is adapted to cover 19 after rotation around its own axis. Cover 19 can be closed in any way, for example by a bayonet closing. The operation can be repeated once or more times, at most until a capsule 15 is arranged into each of chambers 4 of the ice cream maker.

Once this operation has been completed, motor 9 is started, obtaining the rotation of blades 16, with the mixing of the contents of each of capsules 15. Condenser 10 removes from the inside of box 1 the condensation which gradually arises due to the cooling of room air on the outer walls of coolers 4A. Fan 11 causes the cold air to be evenly distributed inside box 1, so as to avoid areas with different temperatures within capsules 15.

The ice cream maker can have multiple, different processing programmes. The rotation speed of motor 9 and, consequently, of blade 16 will depend on the type of raw material which one uses and on the product which one wants to obtain and can be adjusted based on the selected programme. Blades of different shapes and sizes for different preparations can also be provided.

Advantageously, a device of a type known per se can be provided, apt to signal to the user when he or she can stop the operation of motor 9, upon completion of the processing.

The combined action of cold (coolers 4A) and of the rotary movement (blade 16) leads to the formation of the desired final product.

In any case, when the product, ice cream or other, is ready, the operator stops the operation of motor 9, removes covering systems 22 by rotating each one around its own axis, raises by means of handles 20—covers 19 and removes capsules 15 from chambers 4. Normally, at this point, blades 16 and any inserts 17 can also be removed, after having unlocked and removed covers 19.

Capsules 15 can be of such a size as to serve for multiple people, or they can be of a single-portion size, so as not to require further containers to eat the product, once ready.

Generally, capsules 15 are disposable. However, it can also be envisaged to manufacture them as refillable by the manufacturer, as occurs today for certain detergents.

The present invention thus allows to obtain ice cream and similar products, simply by introducing a capsule into the ice cream maker, selecting the relative programme and starting, without the need for preliminary preparations and in absolute hygiene conditions and outcome stability. In particular, it is particularly versatile and allows, unlike what happened up until now, the domestic preparation of products such as frozen yogurt, mousses or crushed ice drinks with the same apparatus, simply by choosing the best suited capsule and operating programme. Moreover, one has the opportunity of easily removing the produced compound and of cleaning the ice cream maker extremely rapidly and effectively.

However, it is understood that the invention must not be considered limited to the particular arrangement illustrated above, which makes up only an exemplifying embodiment thereof, but that different variants are possible, all within the reach of a person skilled in the field, without departing from the scope of protection of the invention, as defined by the following claims.

### LIST OF REFERENCE CHARACTERS

1 Box
2A Half-shell (of 1)
2B Half-shell (of 1)
3 Tray
4 Chamber
4A cooler (of 4)
5 Cover
6 Openings
7 Front bands (of 1)
8A Support
8B Support
9 Motor
10 Condenser
11 Fan
12 Support (of 11)
13 Compressor
14 Crossmember
15 Capsule
16 Blade
17 Insert
18 Coupling (of 16)
19 Cover (of 15)
20 Handle (of 19)
21 Transmission
22 Covering system
22A Lower part (of 22)
22B Upper part (of 22)

1) Ice-cream maker, comprising a cooling unit (4A; 10; 13) and one or more batch freezing containers (4), characterised in that said batch freezing container (4) consists of a compartment where the ingredients for the end product are added in form of cartridge or capsule (15) which is opened and batch frozen upon production within the same container (4).

2) Ice-cream maker as in claim 1, characterised in that said cooling unit consists of a cooler (4A), a condenser (10) and a compressor (13).

3) Ice-cream maker as in claim 1, characterised in that the temperature inside the batch freezing containers (4) can be caused to drop down to −35° C.

4) Ice-cream maker as in claim 1, characterised in that a generally wedge-shaped insert (17) is introduced on the bottom of the capsule (15).

5) Ice-cream maker as in claim 1, characterised in that a device is provided, apt to signal to the user when he or she can halt the operation of the motor (9), to complete processing.

6) Ice-cream maker as in claim 1, characterised in that a fan (11) causes the cold air to be evenly distributed inside the box (1).

7) Ice-cream maker as in claim 1, characterised in that said batch freezing containers are two.

8) Waffle or capsule (15) for an ice-cream maker as in claim 1, characterised in that it contains a mostly liquid or creamy preparation, which contains all the ingredients necessary to obtain the desired product and which have undergone all the preparation steps, excluding the final batch freezing.

9) Waffle or capsule as in claim 8, characterised in that it is made of a material chosen among a recyclable plastic material (PVC, melamine, polyethylene, polypropylene, vynyl-ethylene alcohol) aluminum, a recyclable plastic material lined internally and/or externally with aluminum or other thermoconductive metal.

10) Waffle or capsule (15) as in claim 8, characterised in that the closing film of said cartridge or capsule (15) is made of a plastic material or aluminum.
